(19) United States
(12) Patent Application Publication
(10) Pub. No.: US 2011/0236716 A1
(43) Pub. Date: Sep. 29, 2011

(54) METHOD FOR PRODUCING SHAPED ELEMENTS FROM SHEET STEEL GALVANIZED ON ONE OR BOTH SIDES

(75) Inventors: Stephan Hüffer, Munchen (DE); Helmut Witteler, Wachenheim (DE); Karl-Heinz Stellnberger, Linz (AT); Martin Fleischanderl, Rainbach Im Muhlkreis (AT)

(73) Assignee: BASF SE, Ludwigshafen (DE)

(21) Appl. No.: 13/133,053

(22) PCT Filed: Nov. 23, 2009
(86) PCT No.: PCT/EP09/65620

§ 371 Date: Jun. 6, 2011

(30) Foreign Application Priority Data
Dec. 4, 2008 (EP) 08170656.6

(51) Int. Cl. B23K 31/02; B32B 15/04; G01N 17/00; B23P 17/00; B21D 31/00

(52) U.S. Cl. 428/624; 228/164; 436/6; 72/46; 72/39

(57) ABSTRACT

A method of producing shaped articles made from single-sidedly or double-sidedly galvanized steel sheet, starting from galvanized steel strip, at least one of the steps of the method being a transport operation, and in which, for protection from black-spot corrosion, a corrosion preventive oil is applied which comprises N-acyl derivatives of sarcosinic acid as corrosion inhibitor.

The present invention relates to a method of producing shaped articles made from single-sidedly or double-sidedly galvanized steel sheet, starting from galvanized steel strip, at least one of the steps of the method being a transport operation, and in which, for protection from black-spot corrosion, a corrosion preventive oil is applied which comprises N-acyl derivatives of sarcosinic acid as corrosion inhibitor.

The production of flat metallic ready-made products from galvanized steel, such as automobile bodies or parts thereof, appliance casings, exterior architectural facings, ceiling panels or window profiles, for example, is a multi-stage operation. The raw materials for it are usually galvanized steel strips which are produced by rolling of the metal, followed by galvanizing, and which for storage and transportation are wound to form rolls (referred to as coils). For processing, these coils are wound again, separated into smaller pieces, and shaped by means of suitable techniques such as punching, drilling, folding, profiling and/or deep-drawing. Larger components, such as automobile bodies, for example, are optionally obtained by the joining of two or more individual parts. After shaping and joining have taken place, the product can be painted, for example.

A characteristic of the stated production operation is that not all of the steps referred to are performed in one manufacturing site; instead, as a general rule, precursor products and/or semifinished products must be transported one or more times from one manufacturing site to another. To take as an example the production of automobiles: the production of the metal strips takes place at the premises of a steelmaker. The cutting-up of the strips and the shaping to an automobile body or bodywork parts takes place in a pressing plant, and the manufactured bodies or parts thereof are then transported to an automaker for painting and final assembly.

Also deserving of mention in this context is the “completely knocked down” or “partly knocked down” manufacturing technique for automobiles, where vehicles intended for export are transported deliberately not in the fully assembled state but instead in the form of individual parts to the importing country, and undergo final assembly only in that importing country. With this manufacturing technique, entire bodies or bodywork parts must be transported form the exporting to the importing country, in some instances in ocean voyages that can take several weeks.

In the course of transport, on railroad wagons or in ships, for example, the precursor products and/or semifinished products are subject to atmospheric influences, and must therefore be protected from corrosion for their transport.

For corrosion protection in transport, it is common to apply what is called a “temporary protective”; in other words, this is not yet the final corrosion preventive coating, which is intended to impart permanent protection to the finished product, but is instead a coating which is removed at a later point in the process and replaced by the ultimate corrosion preventive coating. For temporary protection from corrosion, the steel strips are provided generally with a coating of a corrosion preventive oil. Corrosion preventive oils often have a dual function and also act as forming auxiliaries, as during deep-drawing, for example. The forming oil is intended to ensure the necessary lubricity during the shaping operation, so as to prevent fracture or rupture of the metal sheet.

In the transport of shaped articles made from galvanized steel, one specific form of corrosion comes to the fore, namely that known as black-spot corrosion. This is a locally confined, rather than an extensive, form of corrosion. One possible cause of this black-spot corrosion is the possibility of contamination of the metal surfaces by particles in the course of transport. This particulate contamination then leads frequently to very locally confined forms of corrosion around the particles. The particles in question may for example be particles of dirt and/or of salt, or may be particles of salt in association with dirt.

Especially in the case of electrolytically galvanized steel, this form of corrosion also results in a significant change in the surface morphology. Viewed from the side, the metal surface is seen to have, for example, craterlike elevations. In the context of automobile construction, craterlike elevations of this kind are extremely disruptive, since they tend to be exacerbated, and certainly not leveled out, by the subsequent cationic deposition coating process. As a result of the black-spot corrosion, extremely extensive afterwork is necessary on the assembled body. This afterwork not only leads to high costs for the metal producer but also disrupts the time course of the line manufacturing operation. Furthermore, the corrosion resistance of the completed body is adversely affected as well, since remediated spots constitute nucleation cells for the corrosion of the consumer product.

The use of N-acyl derivatives of sarcosinic acid as corrosion inhibitors is known.

JP 2007-039764 A discloses a corrosion control oil composition which comprises a base oil and also N-acyl derivatives of sarcosinic acid and/or the salts or esters thereof.

EP 1 092 788 A2 discloses a composition comprising an N-acylsarcosinic acid and also a substituted triazole in oil, and its use for corrosion prevention in metalworking fluids, hydraulic oils, transmission oils or lubricating oils.

WO 01/088068 discloses an oil composition for the temporary treatment of metallic surfaces for simultaneous lubrication and corrosion control. The oil composition comprises a biodegradable composition which comprises at least two different triglycerides and at least one fatty acid ester of a monoalcohol, and also, optionally, at least one amide derivative from the condensation of a fatty acid and a mono-, di- or trialkanolamide. The compositions may further comprise optionally 0.5% to 5% by weight of at least one corrosion inhibitor, which may also comprise monoimides or derivatives of N-acylsarcosine. The oils are applied in an amount of 0.5 to 3 g/m² to the metallic surface.

DD 148 234 A1 discloses a corrosion preventive and deep-drawing composition for cold-rolled strip, and DD 218 775 A3 discloses cooling lubricant oils, both of which, alongside other components, comprise an oleylsarcosine component.

DD 240 384 A1 discloses temporary corrosion preventive lacquers which comprise a film-forming polymer having a glass transition temperature below 20° C., such as acrylate resins, alkylphenolic resins or nitrocellulose, for example, in a mixture of solvents, such as toluene, ethylbenzene, butanol or butylglycol, for example. The corrosion preventive lacquer further comprises a mixture of zinc octoate, zinc alkyl dithiophosphate, oleylsarcosine, rapeseed oil fatty acid diethylamide, alkylnaphthalene, and mineral oil. The treatment of galvanized steel is not disclosed.

DD 203 567 A1 discloses corrosion preventive oils for the temporary protection of metallic surfaces of semifinished and finished products from atmospheric corrosion in the course of machining, storage, and transport, such as overseas transport, for example. The corrosion preventive oils are composed of 75% to 99.3% by weight of a mineral base oil having a viscosity of 1 to 1000 mm²/s, 0.15% to 15% by weight of a reaction product of alkylarylsulfonic acids and barium hydroxide in the presence of alkylphenols, and 0.2% to 10% by weight of a mixture of two of the three following components in a weight ratio of 1:1, namely 1) amine salts of mono- or dialkylphosphoric esters, 2) mono-, di- or trialkanolamides of oleic acid, or 3) a fatty acid having 10 to 20 carbon atoms or its sarcoside. The corrosion preventive oils were tested on cylindrical plates of grey cast iron, in other words carbon-containing cast iron, by means of a typical climatic-cycling test. With regard to the application of the corrosion preventive oils disclosed, the specification provides no further details beyond what has just been stated.

U.S. Pat. No. 5,555,756 discloses a method for improving the drawability of a steel strip. For this purpose the steel strip is first heated and then a liquid lubricant is applied to the surface, and is subsequently dried to form a dry film on the surface. The amount applied is at least 10.8 mg/m². The steel strip is subsequently rolled. The liquid lubricant comprises preferably water, a surfactant, and an alkyl phosphate ester of the general formulae RO—P(═O)(OH)₂ or (RO)₂—P(═O)OH, with R being an alkyl group having 4 to 20 carbon atoms.

None of the stated specifications, however, is concerned with the problem of black-spot corrosion in the transport of precursor products or semifinished or finished products of galvanized steel in an atmospheric environment.

It was an object of the invention to provide improved corrosion protection for the transport of precursor products and semifinished or finished products made from galvanized steel, allowing effective prevention of salt-grain or black-spot corrosion.

In a first aspect of the invention, a temporary oil-containing corrosion preventive coating for galvanized steel has been found which comprises N-acyl derivatives of sarcosinic acid and which is especially suitable for preventing black-spot corrosion in the transport of precursor products and semifinished or finished products made from galvanized steel.

Accordingly a method has been found of producing shaped articles made from single-sidedly or double-sidedly galvanized steel sheet, said method comprising—in this order—at least the following steps:
(1) applying a corrosion preventive oil to the surface of a galvanized steel strip in an amount of 0.25 to 5 g/m²,
(2) transporting the coated, galvanized steel strip to a fabrication site for shaped articles, and
(3) separating and forming the galvanized steel strip into shaped articles made from single-sidedly or double-sidedly galvanized steel sheet,
   the corrosion preventive oil being a formulation comprising
   50 to 99.5% by weight of at least one oil (A) having a flash point of at least 300° C.,
   0.5 to 50% by weight of at least one active corrosion inhibitor substance (B), and
   0 to 30% by weight of further additives (C),
      the amount figures being based in each case on the total amount of all of the components of the corrosion preventive oil, wherein at least one of the active corrosion inhibitor substances (B) is an active substance (B1) of the general formula R¹—CO—N(R²)—(CH₂)ₙ—COOR³, the definitions of the radicals and indices R¹, R², R³, and n being as follows:
R¹: a saturated or unsaturated, linear or branched hydrocarbon radical having 10 to 20 carbon atoms,
R²: H or a linear or branched C₁ to C₄ alkyl radical,
R³: H or a cation 1/m Y^{m+}, where m is a natural number from 1 to 3, and
n: a natural number from 1 to 4,
   and wherein the amount of the active substance (B1) is at least 0.5%.

In one preferred embodiment of the invention the shaped articles comprise parts of automobile bodies or comprise automobile bodies.

This solution was particularly surprising because N-acyl derivatives of sarcosinic acid, such as oleylsarcosinic acid or laurylsarcosinic acid, for example, are commercially available corrosion inhibitors whose use for a very wide variety of purposes is already known. Nevertheless, compounds of this kind have not hitherto been proposed for preventing black-spot corrosion in the course of the transport of shaped articles made from galvanized steel.

In achieving the object, the difficulty occurred that the known tests for determining the corrosion behavior of a consumer product, such as the climatic cycling test according to VDA [German Association of the Automotive Industry] test sheet 621-415 or the salt spray test according to DIN EN 9227, are not always adequate to provide a precise and comprehensive depiction of the corrosion protection requirements involved in the transport of precursor products and semifinished or finished products made from galvanized steel. For instance, the results in the salt spray test for the N-acyl-sarcosinic acid derivatives used in accordance with the invention were no more than moderate, and hence on the basis solely of the salt spray test, these products would not actually have been considered at all.

In a further aspect of the invention, therefore, a test method is provided that is particularly suitable for investigating the behavior of corrosion inhibitors with regard to their capacity to prevent black-spot corrosion.

Details of the invention now follow.

### Test Method

With the known salt spray tests for determining the corrosion resistance of metal sheets, the entire surface of the test sheet is subjected to a fine mist of salt-containing water; in other words, it involves uniform corrosive exposure of the entire metal surface.

In the method developed in accordance with the invention for testing galvanized steel sheets for their resistance to black-spot corrosion, in contrast, the uniform corrosive exposure is replaced by a pointwise corrosive exposure.

For the conduct of the test, the galvanized steel sheets for testing are stored horizontally in a controlled-climate chamber. For the test, the galvanized steel sheets are coated with the test coating, though for purposes of comparison it is of course also possible to test uncoated sheets. Typical test sheets have a surface area of approximately 0.01 m², though it is of course also possible to use test sheets with other surface areas. Generally speaking, however, the size should not be below 0.0025 m².

For the conduct of the test, the facing side of the sheets is sprinkled with salt-containing test particles. These particles may in the simplest case be salt grains, especially NaCl grains, though it is also conceivable to use test particles of other materials, such as of NaCl-contaminated sand, for example, in order to allow better modeling of dirt particles. The particles may of course also be agglomerates of smaller particles. Generally speaking the particles ought to have a diameter of 0.1 to 1 mm, preferably 0.2 to 0.6 mm. Corresponding particle fractions can easily be provided by sieving. In this test the surface is sprinkled in such a way that the particles are arranged essentially each individually on the surface. The amount of particles ought in general to be 1000 to 25 000 particles/m², preferably 5000 to 15 000 particles/m², and, for example, about 10 000 particles/m²; thus, for a sheet size of 1 dm², approximately 100 particles.

The sheets thus treated are then stored for a defined time at defined humidity and temperature in a suitable apparatus for setting the climatic conditions. The test is carried out preferably at 15 to 40° C., more preferably at room temperature, although other test temperatures are of course also conceivable. A relative humidity of 60% to 90%, 85% for example, and a test time of 12 to 96 h, 24 h for example, have proven suitable. Other test times are of course also conceivable. In particular it is also possible to study the corrosion over the course of time. The test conditions can be adapted by the skilled worker, for example, to the climatic conditions that prevail in the course of transport.

After the respective test time has elapsed, the surface of the sheet is inspected for corrosion around the test particles. The evaluation may in particular be made photographically. Evaluation parameters may include the number of black spots that have appeared on the sheet, and also the respective size of the corroded areas around the test particles. It is additionally possible to record the time profile of the corrosion. For example, it is possible to record when black spots are first observed, or to record the number of black spots as a function of time.

The test according to the invention allows the corrosion behavior of galvanized shaped articles in the course of transport operations to be assessed in a more realistic way than with the known salt spray tests.

Thus, for example, the testing of the inventively used corrosion preventive oil with the inhibitor (B1) by means of a salt spray test produced only moderate results, and so this inhibitor, on the basis of the salt spray test, would not have been contemplated for the present application. Only the test developed in accordance with the invention revealed the particular suitability of the corrosion inhibitor (B1) in preventing black-spot corrosion.

### Corrosion Preventive Oil Used

In accordance with the invention the formulation used as corrosion preventive oil comprises at least one oil (A), at least one active corrosion inhibitor substance (B), and, optionally, further additives (C). The corrosion preventive oil serves on the one hand for corrosion protection, and also has such good lubricant properties that it is also suitable as a forming assistant.

The boiling point of the base oil (A) used is generally at least 300° C. at 1 bar, The base oil (A) for the formulation may comprise mineral oils or synthetically produced oils. Suitable mineral oils may be obtained, for example, by vacuum distillation of crude oil at about 350 to 500° C. Largely aromatic-free mineral oils are especially suitable. Synthetic oils comprise, in particular, poly-α-olefins, such as those of C₁₂ to C₁₄ olefins, for example, polyisobutenes, various long-chain esters, or silicone oils. Additionally it is possible to use relatively high-melting paraffins and blends of these with oils, and also to use waxes and wax emulsions, as well. It will be appreciated that mixtures of two or more different oils can be used, subject to the proviso that they are compatible with one another. Preference for performing the invention is given to mineral oils and synthetic oils based on poly-α-olefins.

Further details of suitable base oils are published in, for example, “Lubricants and Lubrication” in Ullmann's Encyclopedia of Industrial Chemistry, Electronic edition, 7th release, 2007, Wiley-VCH, Weinheim.

Particularly suitable oils are mineral oils having a kinematic viscosity at 20° C. of 50 to 200 mm²/s (measured to ASTM D 445), preferably 120 to 180 mm²/s, and more preferably 140 to 160 mm²/s, a pour point of −15° C. to +5° C., preferably −5° C. to +5° C., measured to ASTM D 97, a density, measured at 15° C. to ASTM D 1298, of 0.85 to 0.90 kg/l, preferably 0.88 to 0.90 kg/l, and a flash point, determined to ASTM D 92, of more than 180° C., preferably more than 200° C.

The amount of all the oils (A) used is together 50% to 99.5%, preferably 70% to 90%, and more preferably 75% to 85%, by weight, based in each case on the total amount of all of the components of the formulation employed.

The formulation employed in accordance with the invention comprises one or more active corrosion inhibitor substances (B). In accordance with the invention these substances comprise at least one active substance (B1) of the formula R¹—CO—N(R²)—(CH₂)ₙ—COOR³. In this formula the definitions of the radicals R¹, R², and R³ and the index n are as follows:
R¹: a saturated or unsaturated, linear or branched hydrocarbon radical having 10 to 20 carbon atoms, preferably 12 to 18 carbon atoms, and more preferably 16 to 18 carbon atoms,
R²: H or a linear or branched C₁ to C₄ alkyl radical, preferably a methyl radical,
R³: H or a cation 1/m Y^{m+}, where m is a natural number from 1 to 3, preferably 1 or 2, and more preferably 1, and
n: a natural number from 1 to 4, preferably 1 or 2, and more preferably 1.

The radical R¹ is preferably a monounsaturated radical having 17 carbon atoms. With particular preference it is a radical derived from oleic acid. Preference is given additionally to radicals derived from lauric acid.

The cations Y^{m+} may in particular be alkali metal ions, more particularly Li⁺, Na⁺ or K⁺, or may be alkaline earth metal ions or ammonium ions. Ammonium ions include NH⁴⁺ and ammonium ions [NR⁴₄]⁺ with organic radicals, the radicals R⁴ each independently of one another being H or hydrocarbon radicals, more particularly hydrocarbon radicals having 1 to 4 carbon atoms. Preferably R³ is H⁺, Na⁺ or NH⁴⁺. It will be appreciated that two or more different radicals may also be involved.

The corrosion inhibitors (B1) can be prepared by methods known in principle to the skilled worker, in particular by reaction of sarcosinic acid and/or its derivatives H—N(R²)—(CH₂)ₙ—COOR³ with carboxylic acids R¹—COOH or with reactive derivatives of the carboxylic acids, such as the corresponding carboxylic anhydrides or carboxylic halides. Corrosion inhibitors (B1) are available commercially.

It will be appreciated that mixtures of two or more different active substances (B1) can also be used, and that mixtures of active substances (B1) with different active corrosion inhibitor substances (B2) can be used.

The amount of all of the corrosion inhibitors (B) used is together 0.5% to 50%, preferably 10% to 30%, and more preferably 15% to 25%, by weight, based in each case on the total amount of all of the components of the formulation employed.

The amount of all of the active substances (B1) together, however, is at least 0.5% by weight. Where further active corrosion inhibitor substances (B2) are present as well, the (B1)/(B2) weight ratio is at least 0.1, preferably at least 0.5, more preferably at least 0.8. With very particular preference, active corrosion inhibitor substances (B1) are used exclusively.

The amount of the corrosion inhibitors (B1) used is preferably together, therefore, 0.5% to 50%, more particularly 5.01% to 50%, preferably 10% to 30%, and more preferably 15% to 25%, by weight, based in each case on the total amount of all of the components of the formulation employed.

The corrosion preventive oil formulation used in accordance with the invention may optionally further comprise additives or auxiliaries (C). Adjuvants of this kind can be used to adapt the properties of the formulation to the desired purpose.

Examples of such additives (C) comprise carboxylic esters, free or partly neutralized carboxylic acids, emulsifiers, such as alkylsulfonates, for example, or antioxidants such as phenolic components, imidazoles, polyether phosphates, alkyl phosphates or succinimides, especially polyisobutylenesuccinimides reacted with oligoamines such as tetraethylenepentamine and/or ethanolamines. Additionally it is also possible to use phosphoric or phosphonic esters, or else antiwear additives, such as zinc dithiophosphate, for example. The skilled person makes an appropriate selection from the additives in accordance with the desired properties of the formulation.

The amount of all of the additives (C) used is together 0% to 30%, preferably 0% to 20%, more preferably 0.5% to 20%, and very preferably 1% to 10%, by weight, based in each case on the total amount of all of the components of the formulation employed.

For use, components (A) and also, optionally (B) and/or (C) are mixed.

In accordance with the invention, the described formulation of a corrosion preventive oil is used for corrosion prevention in the course of the storage and transport of shaped articles made from galvanized steel sheet. The steel sheets typically have a thickness of 0.2 to 3 mm. The steel sheet may be single-sidedly or double-sidedly galvanized.

The term “galvanized” also, of course, comprises steel sheets coated with Zn alloys. These may be steel strips which are hot-dip galvanized or electrolytically galvanized. Zn alloys for coating steel are known to the skilled worker. Depending on the desired application, the skilled worker selects the nature and amount of alloying constituents. Typical constituents of zinc alloys comprise, in particular, Al, Mg, Si, Sn, Mn, Ni, Co, and Cr, preferably Al or Mg. There may also be Al/Zn alloys in which Al and Zn are present in approximately the same amount. The coatings may be largely homogeneous coatings or else coatings with concentration gradients. With further preference the alloys may be Zn/Mg alloys. The steel in question may be a steel coated with a Zn/Mg alloy, such as a hot-dip galvanized steel, for example, or may be a galvanized steel additionally vapor-coated with Mg. In this way it is possible to produce a Zn/Mg alloy at the surface.

These kinds of shaped article include, in particular, those articles which can be used for lining, masking or cladding. Examples comprise automobile bodies or parts thereof, truck bodies, frames for two-wheeled vehicles such as motorcycles or bicycles, or parts for vehicles of this kind, such as fairings or panels, casings for household appliances such as washing machines, dishwashers, laundry driers, gas and electric ovens, microwave ovens, chest freezers or refrigerators, casings for industrial appliances or installations such as, for example, machines, switching cabinets, computer housings or the like, structural elements in the architectural sector, such as wall parts, facing elements, ceiling elements, window profiles, door profiles or partitions, furniture made from metallic materials, such as metal cupboards, metal shelving, furniture parts or else fittings. The articles may also be hollow articles for the storage of liquids or other substances, such as, for example, tins, cans or tanks. The term “shaped article” also comprises precursor products in the manufacture of the stated materials, such as steel strips or steel sheets, for example.

Use is performed by applying the corrosion preventive oil, prior to storage and/or to transport, to the galvanized surface, in an amount of 0.25 to 5 g/m², preferably 0.5 to 3 g/m², and more preferably 1 to 2.5 g/m².

“Transport” here refers to all kinds of transport operations in which the shaped articles are moved from one location to another location. The first location may in particular be the site of fabrication of the shaped articles, but may alternatively be a temporary storage facility. The second location is in particular another fabrication site, at which the shaped articles obtained are subjected to further processing. For example, the first location may be a pressing plant where automobile bodies or bodywork parts are manufactured, and the second location may be an automobile assembly facility.

“Storage” refers to all kinds of storage operations. This may involve brief temporary storage of several hours to several days, or else a longer storage of several weeks to several months.

### Method of Producing Shaped Articles

In one preferred embodiment of the method, the corrosion preventive oil is used by means of the method of the invention as described below, in which shaped articles made from single-sidedly or double-sidedly galvanized steel sheet are produced.

Starting material used for the method of the invention comprises galvanized steel strips. Galvanized steel strips typically have a thickness of 0.2 to 3 mm and a width of 0.5 to 2.5 m. Galvanized steel strips are available commercially for a very wide variety of applications. They may be single-sidedly or double-sidedly galvanized steel strips. The skilled worker selects a suitable steel strip in accordance with the desired end use.

The term “galvanized” also, of course, comprises steel strips coated with Zn alloys. Suitable zinc alloys have already been described.

Step (1) of the Method

In step (1) of the method the above-described corrosion preventive oil is applied to the surface of the galvanized steel strip. Where the strip is a single-sidedly galvanized strip, the formulation used in accordance with the invention is applied at least to the galvanized side, but may of course also be applied to the ungalvanized side. The ungalvanized side may also, however, be treated with a different corrosion preventive oil.

Application may take place, for example, by spraying, including in particular by spraying with assistance from an electrostatic field. Moreover, application may be made using a Chemcoater or else by immersion in an oil bath, followed by squeezing off, or, alternatively, by spraying of the oil on to the metal sheet, followed by squeezing off.

The amount of the corrosion preventive oil applied to the surface is generally 0.25 to 5 g/m², preferably 0.5 to 3 g/m², and more preferably 1 to 2.5 g/m².

The corrosion preventive oil may be applied preferably immediately after the steel strip has been produced, in other words, typically, in a steel plant or rolling plant.

This, however, does not rule out the application of the corrosion preventive oil only at a later point in time.

The active corrosion inhibitor substance (B1) used in accordance with the invention also acts as a surfactant and ensures particularly uniform distribution of the oil on the metal surface. Moreover, the active substance exhibits strong IR absorptions, particularly the >C═O band, and so the application of the oil can be controlled and monitored to particularly good effect by means of IR spectroscopy.

### Step (2) of the Method

In step (2) of the method the oiled, galvanized steel strip is transported to a fabrication site for shaped articles. Fabrication sites for shaped articles are, for example, pressing plants, in which automobile bodies and/or parts of automobile bodies are produced.

For the purpose of transport, the galvanized steel strips are commonly rolled up to form coils. The transport in question is preferably transport by truck and/or rail. The steel strips may be transported immediately after step (1) of the method or may first be stored temporarily before being transported.

### Step (3) of the Method

At the fabrication site for shaped articles, the oiled, galvanized steel strips are separated and shaped to form articles. Fabrication sites for shaped articles are, for example, pressing plants in which automobile bodies and/or parts of automobile bodies are produced.

In the course of separation, the galvanized, oiled steel strip is separated into appropriately sized pieces, and also, optionally, particles of material are separated from the undivided material for the purpose of further shaping. The separation techniques may be machining techniques or shaping techniques. Separation may be performed, for example, by punching or cutting using appropriate tools. Cutting may also be undertaken thermally, by means of lasers, for example, or else by means of sharp jets of water. Examples of further separating techniques comprise techniques such as sawing, drilling, milling or filing. The cutting of the metal strip is sometimes also referred to as slitting.

In the forming process, shaped articles are produced, from the individual metal sheets obtained at separation, by means of plastic alteration in shape. The forming operation may be a cold or hot forming process. Preferably it is a cold forming process. Forming may, for example, involve compressive forming, such as rolling or embossing, tensile compressive forming, such as cold-drawing, deep-drawing, roll-bending or press-bending, tensile forming such as lengthening or widening, flexural forming such as bending, edge-rolling or edging, and shearing forming such as twisting or dislocating. Details concerning such forming techniques are known to the skilled worker. The operations are also recorded, for example, in the form of relevant standards, such as DIN 8580 or DIN 8584, for example. One method particularly preferred for implementing the present invention is that of deep-drawing.

In one embodiment of the invention the corrosion preventive oil applied in step (1) of the method remains on the surface and functions also as a lubricant for forming.

In another embodiment of the method, the individual sheets can also first be cleaned after having been separated. This cleaning may be performed, for example, by rinsing with water. After rinsing with water, the sheets may be squeezed off. Subsequently the corrosion preventive used in accordance with the invention, and/or forming oil, may be applied in an amount of 0.5 to 50 g/m².

The resulting shaped articles can be subjected to further processing in further method steps in the same manufacturing site, by means of cleaning, application of a permanent corrosion protective, and coating, for example, optionally also after joining to form assembled shaped articles.

### Step (4) of the Method

In one preferred embodiment of the method, the shaped articles obtained in step (3), examples being parts of automobile bodies, are transported in a further step (4) of the method to a further fabrication site, an automobile assembly facility, for example. The transport in question may preferably be by truck or by rail. The shaped articles may be transported immediately after step (3) of the method, or may first be stored temporarily before being transported. At the further fabrication site, the shaped articles obtained in step (3) are subjected to further processing.

### Step (5) of the Method

In the preferred embodiment of the method, the further processing comprises at least one step (5) of the method, in which the shaped articles obtained in step (3) are joined to other shaped articles to form assembled shaped articles. This can be done, for example, by pressing, welding, soldering, adhesive bonding, screwing or riveting. For example, an automobile body may be assembled from a plurality of individual parts.

Joining may be carried out using two or more identical or different shaped parts obtained in step (3), or else different kinds of shaped articles may be employed. For example, shaped articles made from galvanized steel, ungalvanized steel, and aluminum may be combined with one another to form an assembled shaped article.

The assembled shaped articles made from galvanized steel can subsequently be processed further in a conventional way to form the intermediate products or end products, as for example by cleaning, phosphating, and the application of various paint coats.

### Shaped Articles

In a further aspect, the invention provides shaped articles made from single-sidedly or double-sidedly galvanized steel sheet which comprise a film of a corrosion preventive oil applied to the galvanized surface in an amount of 0.25 to 5 g/m², the composition of the corrosion preventive oil being that already described above. Preferred compositions have already been given and preferred film thicknesses are the values already stated. Examples of such shaped articles have likewise been given above. The shaped articles may also be metal panels or laser-welded circuit boards. Preferably they are automobile bodies or parts of automobile bodies.

The shaped articles may be produced preferably by the method of the invention. In principle, however, their production may also take place by other methods. Thus, for example, the corrosion protection of the steel strips and/or the corrosion protection in the course of separating and of forming to give the shaped articles may be ensured, for example, by means of other methods, in other words using, for example, different corrosion inhibitors, and the corrosion preventive oil used in accordance with the invention may only be applied after the shaped article has been produced. In this way the shaped article can be protected for transport. Application may take place, for example, by spraying.

### Use of a Corrosion Preventive Oil

In a further aspect the invention provides for the use of a corrosion preventive oil for corrosion protection in the course of the storage and transport of shaped articles made from galvanized steel sheet, by application of the oil in an amount of 0.25 to 5 g/m² to the surface of the shaped article, the composition of the corrosion preventive oil being that already described above, and preferred compositions, preferred film thicknesses, and examples of shaped articles having already been given above. The shaped articles may also be metal strips, especially rolled metal strips, metal panels or laser-welded circuit boards. Preferably they are automobile bodies or parts of automobile bodies. The oil may be applied by means of various techniques, such as by spraying, for example.

### Advantages of the Invention

Through the use of the above-described corrosion preventive oil featuring the active corrosion inhibitor substances (B1) it is possible to avoid the occurrence of black-spot corrosion in a particularly effective way, or at least to significantly reduce it. Furthermore, the inventively used corrosion preventive oil comprising the base oil (A) and the corrosion inhibitor (B1) assists the forming operation, more particularly the deep-drawing, slitting and roll forming, by means of an excellent lubricating performance. Moreover, the shaped articles coated in accordance with the invention can be readily adhesively bonded without the corrosion preventive oil hindering the bonding operation, and, finally, the shaped articles can be cleaned and phosphated without the phosphating being adversely affected in terms of phosphate coat weight, coat homogeneity or crystal size.

The examples below are intended to illustrate the invention.

### Corrosion Preventive Formulation Used:

The following corrosion inhibitor (B1) was used:

Oleylsarcosinic acid C₁₇H₃₃—CO—N(CH₃)—COOH

For the experiments, a commercial white oil having the following properties was used:

Boiling point: >300° C.
Density at 15° C.: 0.887 kg/l
Viscosity at 20° C. (measured to ASTM D 445): 145 mm²/s
Viscosity at 40° C. (measured to ASTM D 445): 36 mm²/s
Flash point (measured to ASTM D 92): 214° C.

Pour point (measured to ASTM D 97): 3° C.

The corrosion inhibitor was dissolved in the white oil at a concentration of 20% by weight.

### Coating and Testing of the Metal Sheets:

With the formulation obtained, test sheets of galvanized steel measuring 10 cm×15 cm were coated in a quantity of 1.5 g/m². For this purpose the test sheet was placed on a precision balance, and the formulation was applied in the quantity stated to the surface of the sheet using a precision syringe. The amount applied was subsequently distributed over the metal surface by means of a rubber roller having a smooth surface and a Shore A hardness of 50, with forceful pressing.

For comparison purposes, a test sheet was coated only with the oil (A), without addition of the corrosion inhibitor (B1).

For comparison purposes, furthermore, a commercial alkylphosphoric ester (C₁₆/C₁₈ alkylphosphoric ester) was used as corrosion preventive oil. It was employed without oil as diluent.

### Black Spot Test

The sheets treated in this way were sprinkled with salt grains (NaCl) having a size of about 0.1 to 1 mm. The density per unit area was approximately 25 000 salt grains/m² (about 250 salt grains/dm²). Subsequently the panels were stored vertically for 24 h in a controlled-climate chamber at 20° C. and 85% humidity. Following storage, the sheets were rinsed and dried and evaluated photographically.

### Salt Spray Test

Furthermore, for comparison purposes, the sheets were used to carry out a customary salt spray test in accordance with DIN EN 9227, i.e., the entire metal surface was exposed uniformly to a fine salt mist in a test chamber.

### Discussion of the Results

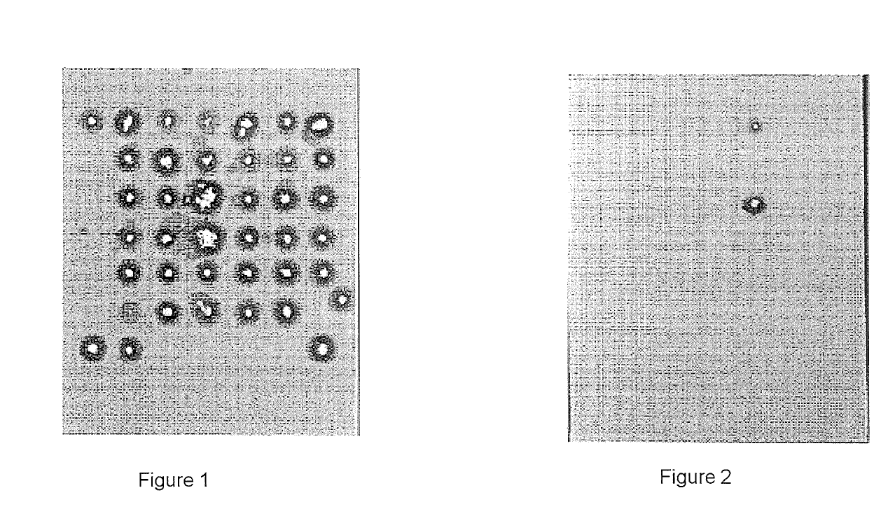

FIG. 1 shows the comparative experiment without addition of the active substance (B1), and FIG. 2 with the addition of the active substance (B1). It is seen that the number of black spots in FIG. 2 is significantly fewer. Whereas the sheets treated with the corrosion preventive oil without active substance (B1) show about 40 black spots/dm² (see FIG. 1), the number with the sheets treated in accordance with the invention is less than 5 black spots/dm², and on some test sheets only 0-1 spot/dm² (see FIG. 2).

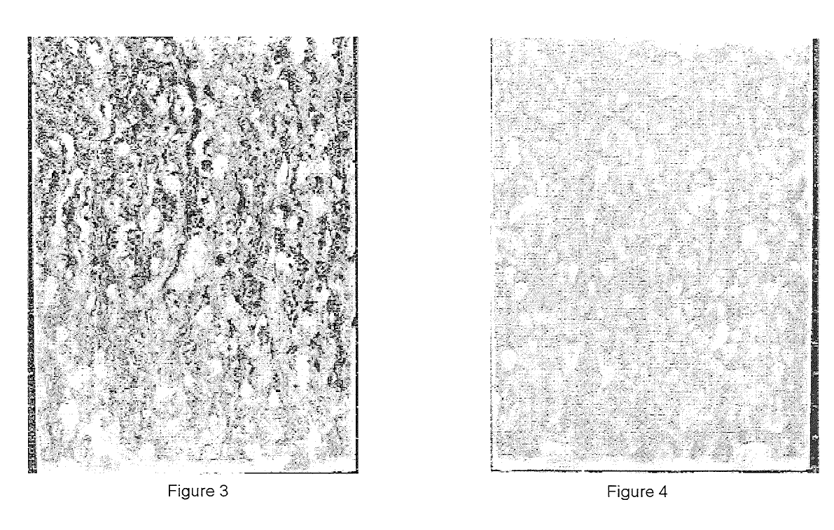

FIGS. 3 and 4 show the test of the same sheets in a conventional salt spray test. FIG. 3 shows a sheet without active substance (B1) after 96 hours of salt spray testing, FIG. 4 the corresponding sheet with active substance (B1). In the salt spray test as well, a certain effect of the active substance (B1) is apparent, but the test with active substance also shows only average results, on the basis of which the active substance (B1) would not be classed as being particularly suitable for corrosion control during transportation. In the black spot test according to the invention, in contrast, the differences between the two sheets are very much clearer.

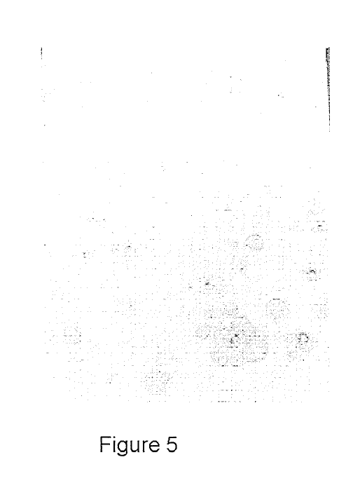

FIG. 5 shows a photograph of the sheet coated, for comparison purposes, with a commercial alkylphosphoric ester, after a test duration of 96 hours. On this sheet as well, a significant number of black spots are already apparent. Not every corrosion inhibitor is equally suited as a corrosion inhibitor for corrosion control during transportation.

1.-15. (canceled)

16. A method of producing shaped articles made from single-sidedly or double-sidedly galvanized steel sheet, comprising:
(1) applying a corrosion preventive oil to the surface of a galvanized steel strip in an amount of 0.25 to 5 g/m²,
(2) transporting the oiled, galvanized steel strip to a fabrication site for shaped articles, and
(3) separating and forming the oiled, galvanized steel strip into shaped articles made from single-sidedly or double-sidedly galvanized steel sheet, the corrosion preventive oil comprising:
50 to 99.5% by weight of at least one oil (A) having a flash point of at least 180° C.,
0.5 to 50% by weight of at least one active corrosion inhibitor substance (B), and
0 to 30% by weight of further additives (C),
the percentages being based in each case on the total amount of all of the components of the corrosion preventive oil, wherein at least one of the active corrosion inhibitor substances (B) is an active substance (B1) of the general formula R¹—CO—N(R²)—(CH₂)ₙ—COOR³, the definitions of the radicals and indices R¹, R², R³, and n being as follows:
R¹: a saturated or unsaturated, linear or branched hydrocarbon radical having 10 to 20 carbon atoms,
R²: H or a linear or branched C₁ to C₄ alkyl radical,
R³: H or a cation 1/m Y^{m+}, where m is a natural number from 1 to 3, and
n: a natural number from 1 to 4,
with the proviso that at least 0.5% by weight of the active substance (B1) is used.

17. The method according to claim 16, wherein the oil (A) is a mineral oil.

18. The method according to claim 16, wherein the oil (A) has a kinematic viscosity, measured in accordance with ASTM D 445 at 20° C., of 50 to 200 mm²/s.

19. The method according to claim 16, wherein the method after step (3) further comprises the following step:
(4) transporting the shaped articles produced in step (3) to a further fabrication site.

20. The method according to claim 19, wherein the method after step (4) further comprises the following step:
(5) joining the shaped articles to other shaped articles to form assembled shaped articles.

21. The method according to claim 16, wherein the shaped articles produced in step (3) are parts of automobile bodies.

22. The method according to claim 20, wherein the assembled shaped articles produced in step (5) are automobile bodies.

23. The method according to claim 16, wherein, step (3) comprises:
(a) separating the metal strip into individual sheets and cleaning the sheets; and
(b) applying a second corrosion preventive oil of the stated composition in an amount of 0.25 to 3 g/m².

24. The method according to claim 16, wherein the transport of step (2) is transport by truck or by rail.

25. The method according to claim 16, wherein the composition of the corrosion preventive oil comprises:
70 to 90% by weight of at least one oil (A) having a flash point of at least 180° C.,
10 to 30% by weight of at least one active corrosion inhibitor substance (B), and
0 to 20% by weight of further additives (C).

26. A shaped article made from single-sidedly or double-sidedly galvanized steel sheet, comprising a film of a corrosion preventive oil applied to the galvanized surface in an amount of 0.25 to 5 g/m², the corrosion preventive oil being a formulation comprising
70 to 90% by weight of at least one oil (A) having a flash point of at least 180° C.,
10 to 30% by weight of at least one active corrosion inhibitor substance (B), and
0 to 20% by weight of further additives (C),
the percentages being based in each case on the total amount of all of the components of the corrosion preventive oil, wherein at least one of the active corrosion inhibitor substances is an active substance (B1) of the general formula R¹—CO—N(R²)—(CH₂)ₙ—COOR³, the definitions of the radicals and indices R¹, R², R³, and n being as follows:
R¹: a saturated or unsaturated, linear or branched hydrocarbon radical having 10 to 20 carbon atoms,
R²: H or a linear or branched C₁ to C₄ alkyl radical,
R³: H or a cation 1/m Y^{m+}, where m is a natural number from 1 to 3, and
n: a natural number from 1 to 4.

27. The shaped article according to claim 25, comprising parts of automobile bodies or comprising automobile bodies.

28. A method of corrosion protection in the course of storage and/or transport of a shaped article made from single-sidedly or double-sidedly galvanized steel sheet, comprising: applying to the shaped-article surface of the oil in an amount of 0.25 to 5 g/m², the corrosion preventive oil being a formulation comprising
70 to 90% by weight of at least one oil (A) having a flash point of at least 180° C.,
10 to 30% by weight of at least one active corrosion inhibitor substance (B), and
0 to 20% by weight of further additives (C),
the percentages being based in each case on the total amount of all of the components of the corrosion preventive oil, wherein at least one of the active corrosion inhibitor substances (B) is an active substance (B1) of the general formula R¹—CO—N(R²)—(CH₂)ₙ—COOR³, the definitions of the radicals and indices R¹, R², R³, and n being as follows:
R¹: a saturated or unsaturated, linear or branched hydrocarbon radical having 10 to 20 carbon atoms,
R²: H or a linear or branched C₁ to C₄ alkyl radical,
R³: H or a cation 1/m Y^{m+}, where m is a natural number from 1 to 3, and
n: a natural number from 1 to 4.

29. The method according to claim 28, wherein the shaped article is an automobile body.

30. A method of testing a galvanized steel sheet for its resistance to black-spot corrosion, comprising:
(a) storing the galvanized steel sheet horizontally in a controlled-climate chamber;
(b) sprinkling the galvanized steel sheet with salt-containing test particles with a diameter of 0.1 to 1 mm in an amount of 1000 to 25 000 particles/m², so that the particles lie essentially each individually on the surface of the galvanized steel sheet to form a treated sheet;
(c) storing the treated sheet for a defined time and temperature at a relative humidity of 75% to 95%; and
(d) inspecting the surface of the treated sheet for corrosion around the test particles.

31. The method according to claim 30, wherein the galvanized steel sheet contains a corrosion preventive coating on the galvanized surface.
